(19) United States
(12) Patent Application Publication
(10) Pub. No.: US 2007/0146518 A1
(43) Pub. Date: Jun. 28, 2007

(54) ARRAY SUBSTRATE AND LIQUID CRYSTAL DISPLAY DEVICE HAVING THE SAME

(76) Inventors: Won-Kee HONG, Seoul (KR); Byoung-Jun Lee, Suwon-si (KR)

Correspondence Address: Frank Chau, Esq.;F. CHAU & ASSOCIATES, LLC, 130 Woodbury Road, Woodbury, NY, 11797, US

(21) Appl. No.: 11/559,474

(22) Filed: Nov. 14, 2006

(30) Foreign Application Priority Data
Dec. 27, 2005 (KR) 2005-130328

(51) Int. Cl. H04N 5/335

(52) U.S. Cl. 348/308

(57) ABSTRACT

An array substrate comprises a first pixel part including a plurality of first effective pixels and a plurality of first dummy pixels, wherein the first effective pixels are disposed in a display area, and the first dummy pixels are disposed in a peripheral area, the peripheral area being formed around the display area, and a second pixel part including a plurality of second effective pixels and a plurality of second dummy pixels, the second pixel part being adjacent to the first pixel part, wherein the second effective pixels are disposed in the display area, and the second dummy pixels are disposed in the peripheral area.

### CROSS-REFERENCE TO RELATED APPLICATION

This application claims priority to Korean Patent Application No. 2005-130328 filed on Dec. 27, 2005, the contents of which are herein incorporated by reference in their entireties.

### BACKGROUND OF THE INVENTION

1. Technical Field

The present disclosure relates to an array substrate and a liquid crystal display device having the same, and more particularly, to an array substrate for preventing display defects and a liquid crystal display device having the same.

2. Discussion of the Related Art

A liquid crystal material included in a liquid crystal display (LCD) device may deteriorate when an electric field having the same polarity is applied to the liquid crystal material for an extended duration. A pixel voltage corresponding to a common voltage can be driven by reversing polarity of the pixel voltage to prevent the deterioration of the liquid crystal material. That is, when a pixel charges a signal voltage having positive polarity in the current frame, the pixel charges a signal voltage having negative polarity in the subsequent frame.

Polarity inversion driving methods such as, for example, a frame inversion method, a line inversion method, a column inversion method, and a dot inversion method are used to reduce the deterioration of the liquid crystal material. The polarity inversion driving methods use a fact that an average brightness of each pixel is substantially constant in a given area because human eyes simultaneously recognize several pixels in a given area. However, patterns displayed in the polarity inversion driving methods may generate a flicker.

The flicker can be generated by transmittance differences between pixels having two opposite polarities when the liquid crystal material alternately charges the positive voltage and the negative voltage. That is, because each dot included in an array substrate is disposed in a plane and voltages controlling each dot are applied only in one direction, a resistance capacitance (RC) delay is generated according to a length of an LCD panel so that the same voltage may not be applied to each dot. Accordingly, the flicker can be generated at lateral line patterns in the line inversion method, at longitudinal line patterns in the column inversion method, and at dot patterns in the dot inversion method.

In an LCD panel having an alternately arranged transistor (AAT) structure, swing numbers of a driving integrated circuit (IC) are reduced by a column inversion method so that power consumption of the LCD panel may be reduced.

In the LCD panel having the AAT structure, first pixels arranged in odd-numbered lines are electrically connected to data lines disposed to the right of the first pixels, and second pixels arranged in even-numbered lines are electrically connected to data lines disposed to the left of the second pixels. Data signals transferred by first data lines are supplied to the first pixels. Data signals transferred by second data lines adjacent to the first data lines are supplied to the second pixels. Thus, neighboring pixels arranged in a line direction and neighboring pixels arranged in a column direction charge data signals having different polarities form each other.

In the LCD panel having the MT structure, flickering at longitudinal line patterns generated in the column inversion method, and an overlay type of coupling can be reduced.

However, the number of pixels that are electrically connected to adjacent data lines to charge data signals is reduced by half in a first data line and a last data line. Thus, brightness differences between adjacent lines due to charge rate differences are generated so that display defects may occur.

### SUMMARY OF THE INVENTION

Embodiments of the present invention provide an array substrate for preventing a flicker from being generated in an LCD panel having an alternately arranged transistor (AAT) structure.

Embodiments of the present invention provide an LCD device having the array substrate for preventing the flicker from being generated,

According to an embodiment of the present invention, an array substrate comprises a first pixel part including a plurality of first effective pixels and a plurality of first dummy pixels, wherein the first effective pixels are disposed in a display area, and the first dummy pixels are disposed in a peripheral area, the peripheral area being formed around the display area, and a second pixel part including a plurality of second effective pixels and a plurality of second dummy pixels, the second pixel part being adjacent to the first pixel part, wherein the second effective pixels are disposed in the display area, and the second dummy pixels are disposed in the peripheral area.

According to an embodiment of the present invention, an array substrate comprises a plurality of gate lines arranged in a first direction, wherein each of the plurality of gate lines is extended in a second direction, and a plurality of data lines each of which is extended in the first direction and intersects the plurality of gate lines to define a plurality of unit pixel areas, wherein a first pixel part and a second pixel part are alternately arranged in the first direction in the unit pixel areas, wherein the first pixel part includes first effective pixels and first dummy pixels disposed in the second direction and the second pixel part includes second effective pixels and second dummy pixels disposed in the second direction, wherein the data lines include a first data line electrically connected to the first dummy pixels and the second effective pixels, a second data line to an n-th data line electrically connected to the first effective pixels and the second effective pixels the second data line being adjacent to the first data line, and a dummy data line electrically connected to the first effective pixels and the second dummy pixels, the dummy data line being adjacent to the n-th data line.

According to an embodiment of the present invention, a liquid crystal display (LCD) device comprises an upper substrate, a liquid crystal layer, and a lower substrate combined with the upper substrate to contain the liquid crystal, wherein the lower substrate includes: a first pixel part having a plurality of first effective pixels disposed in a display area and a plurality of first dummy pixels disposed in a peripheral area formed around the display area, and a second pixel part having a plurality of second effective pixels disposed in the display area and a plurality of second dummy pixels disposed in the peripheral area, the second pixel part being adjacent to the first pixel part.

### BRIEF DESCRIPTION OF THE DRAWINGS

Exemplary embodiments of the present invention can be understood in more detail from the following description taken in conjunction with the accompanying drawings, in which,

FIG. 1 is a block diagram illustrating an LCD device in accordance with an embodiment of the present invention,

FIG. 2 is a cross-sectional view of the LCD panel shown in FIG. 1 in accordance with an embodiment of the present invention;

FIG. 3 is a cross-sectional view of an LCD panel in accordance with an embodiment of the present invention; and

FIG. 4 is a block diagram illustrating an LCD device in accordance with an embodiment of the present invention.

### DETAILED DESCRIPTION OF EXEMPLARY EMBODIMENTS

The present invention is described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components; regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass 1s different orientations of the device in use or operation in addition to the orientation depicted in the figures, For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise, it will be further understood that the terms “comprises” and/or “comprsing,” when used in this specification, specify the presence of stated features, integers, steps, operations, elements and/or components, but do not preclude the presence or addition of one or more other features, integers, steps, operations, elements, components, and/or groups thereof.

Example embodiments of the invention are described herein with reference to cross-section illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs it will be further understood that terms, such as those defined in commonly used dictionaries, should be interpreted as having a meaning that is consistent with their meaning in the context of the relevant art and will not be interpreted in an idealized or overly format sense unless expressly so defined herein.

Hereinafter, the present invention wail be explained in detail with reference to the accompanying drawings.

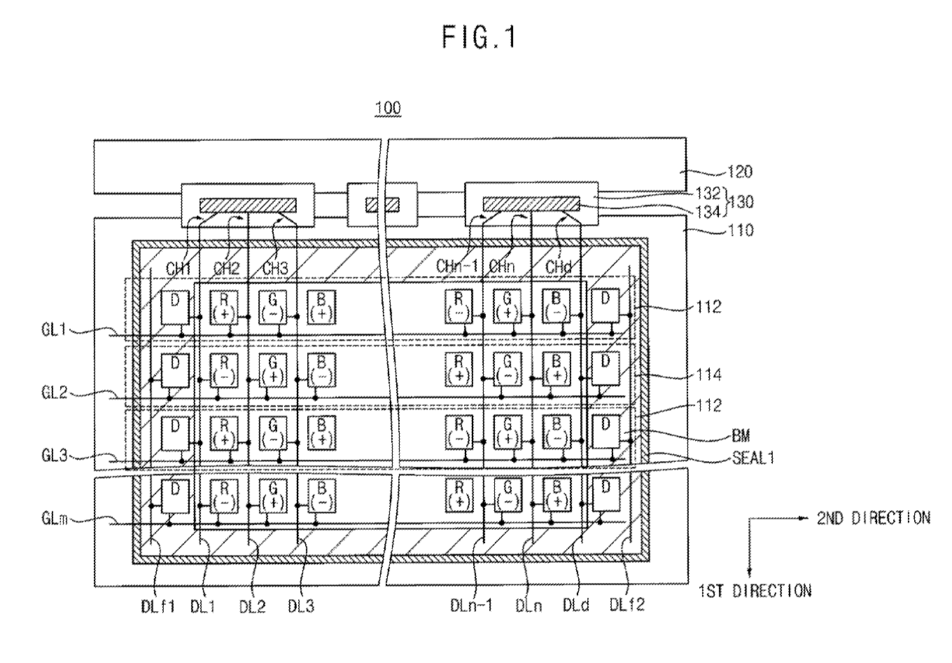

FIG. 1 is a block diagram illustrating an LCD device in accordance with an embodiment of the present invention. FIG, 1 shows an LCD device including a data driving chip with a dummy line.

Referring to FIG. 1, an LCD device 100 includes an LCD panel 110, a printed circuit board (PCB) 120 and a data driving unit 130.

The LCD panel 110 includes a plurality of effective data lines DL1, DL2, . . . , DLn (n is a natural number), a dummy data line DLd, a first floating data line DLf1, a second data floating line DLf2, a plurality of gate lines GL1, GL2, . . . , GLm (m is a natural number), a first pixel part 112 and a second pixel part 114. Each of the first and second pixel parts 112 and 114 contains a switching element (not shown), a liquid crystal capacitor (not shown) electrically connected to the switching element, and a storage capacitor (not shown). The first and second pixel parts 112 and 114 are disposed in a display area defined by an inner side of a light shielding layer BM. The light shielding layer BM is disposed in an area defined by a first sealing material SEAL1.

In an embodiment of the present invention, the effective data lines DL1, DL2, . . . , DLn and the dummy data line DLd are extended in a first direction substantially parallel to a side of the LCD panel 110, and the effective data lines DL1, DL2, . . . , DLn and the dummy data line DLd are sequentially arranged in a second direction substantially perpendicular to the first direction, for example, from the left to the right in FIG. 1. The effective data lines DL1, DL2, . . . , DLn and the dummy data line DLd transfer a plurality of data signals to the first pixel part 112 or the second pixel part 114.

The effective data lines DL1, DL2, . . . , DLn are disposed in the display area, and supply the data signals provided by the data driving unit 130 to the first and second pixel parts 112 and 114.

In an embodiment of the present invention, each of the gate lines GL1, GL2, . . . , GLm is extended in the second direction, and the gate lines GL1, GL2, . . . , GLm are sequentially arranged in the first direction, for example, from the top to the bottom in FIG. 1. The gate lines GL1, GL2, . . . , GLm transfer a plurality of gate signals to the first pixel part 112 or the second pixel part 114. The gate signals turn on or turn off the switching element included in the first pixel part 112 or the second pixel part 114.

The gate lines GL1, GL2, . . . , GLm and the data lines DL1, DL2, . . . , DLn, and DLd form a plurality of unit pixel areas arranged in a matrix. The first pixel part 112 is disposed in odd-numbered rows of the unit pixel areas when counted from the top to the bottom. Adjacent pixels of the first pixel part 112 charge data signals having different polarities from each other with respect to a common voltage. The first pixel part 112 includes a plurality of first effective pixels disposed in the display area of the LCD panel 110 and a plurality of first dummy pixels disposed in a peripheral area of the LCD panel 110. The peripheral area refers to an area formed around the display area.

Each of the first effective pixels is electrically connected to the second data line DL2 to the n-th data line DLn and the dummy data line DLd. Each of the first effective pixels is electrically connected to the odd-numbered gate lines GL1, GL2, . . . , GL2k-1 (k is a natural number) when counted from the top to the bottom. The first dummy pixels are disposed in the peripheral area and are covered by the light shielding layer BM. In an embodiment of the present invention, some parts of the first dummy pixels are disposed to the left of the display area of the LCD panel 110, and the other parts are disposed to the right of the display area of the LCD panel 110.

The second pixel part 114 is disposed in even-numbered rows of the unit pixel areas when counted from the top to the bottom Adjacent pixels of the second pixel part 114 charge data signals having different polarities from each other with respect to the common voltage. The second pixel part 114 is disposed adjacent to the first pixel part 112. The second pixel part 114 includes a plurality of second effective pixels disposed in the display area of the LCD panel 110 and a plurality of second dummy pixels disposed in the peripheral area of the LCD panel 110.

Each of the second effective pixels is electrically connected to the first data line DL1 to the n-th data line DLn. Each of the second effective pixels is electrically connected to the even-numbered gate lines GL2, GL4, . . . , GL2k (k is a natural number) when counted from the top to the bottom. The second dummy pixels are disposed in the peripheral area and are covered by the light shielding layer BM. In an embodiment of the present invention, some parts of the second dummy pixels are disposed to the left of the display area of the LCD panel 110, and the other parts are disposed to the right of the display area of the LCD panel 110.

The LCD panel 110 may further include the first floating data line DLf1 disposed to the left of the first data line DL1 and the second floating data line DLf2 disposed to the right of the dummy data line DLd. The first and second floating data lines DLf1 and DLf2 are formed in the peripheral area. The first floating data line DLf1 is electrically connected to the second pixel part 114, and more particularly to the second dummy pixels disposed to the left of the display area. The second floating data line DLf2 is electrically connected to the first pixel part 112, and more particularly to the first dummy pixels disposed to the right of the display area.

The PCB 120 is disposed adjacent to a side portion of the LCD panel 110. The PCB 120 includes for example, a timing control part (not shown) and a power source convert part (not shown). The timing control part receives image signals provided from outside and sync signals corresponding to the image signals. The power source convert part converts a source voltage provided from outside.

The timing control part, for example, converts the image signals and the sync signals to be adapted to an LCD device, and supplies the converted image signals and sync signals to the data driving unit 130. The power source convert part, for example, generates a gate on/off voltage and a common voltage. The gate on/off voltage turns on or turns off the switching element.

The data driving unit 130 may be disposed between the LCD panel 110 and the PCB 120. The data driving unit 130 includes a plurality of flexible printed circuit (FPC) boards 132 and data driving chips 134 mounted on the FPC boards 132. In an embodiment of the present invention, the FPC boards 132 are arranged in the second direction. Each of the FPC boards 132 has an input pattern part (not shown) to which signals are inputted, an output pattern part (not shown) from which processed signals are outputted, and a dummy pattern part (not shown).

The input pattern part is electrically connected to the PCB 120, and the output pattern part is electrically connected to the LCD panel 110.

The output pattern part is electrically connected to the data driving chip 134 through a first channel line CH1 to an n-th channel line CHn. Each of the channel lines CH1, CH2, . . . , CHn-1 and CHn is electrically connected to the effective data lines DL1, DL2, . . . , DLn-1 and DLn, respectively.

The dummy pattern part is electrically connected to a dummy channel CHd included in the gate driving chip 134. The gate driving chip 134 adapted for an LCD device with a wide extended graphics array (WXGA) resolution (1024×768 pixels) can have 12 dummy channels. One of the dummy channels is electrically connected to the dummy data line DLd. The dummy data line DLd is electrically connected to S the most right pixels of the first effective pixels that are disposed in the most right column in the effective unit pixel matrix. The dummy data line DLd is electrically connected to the right dummy pixels that are disposed to the right of the display area.

Accordingly, the dummy channel included in the data driving chip 134 and the dummy data line DLd included in the LCD panel 110 are electrically connected with 10 each other so that the dummy pixels covered by the light shielding layer BM and the effective pixels disposed in the display area may maintain a uniform charge rate. Thus, charge rate differences between adjacent pixels disposed in the same rows in the unit pixel matrix is reduced so that display defects generated by brightness differences between the adjacent pixels may be prevented.

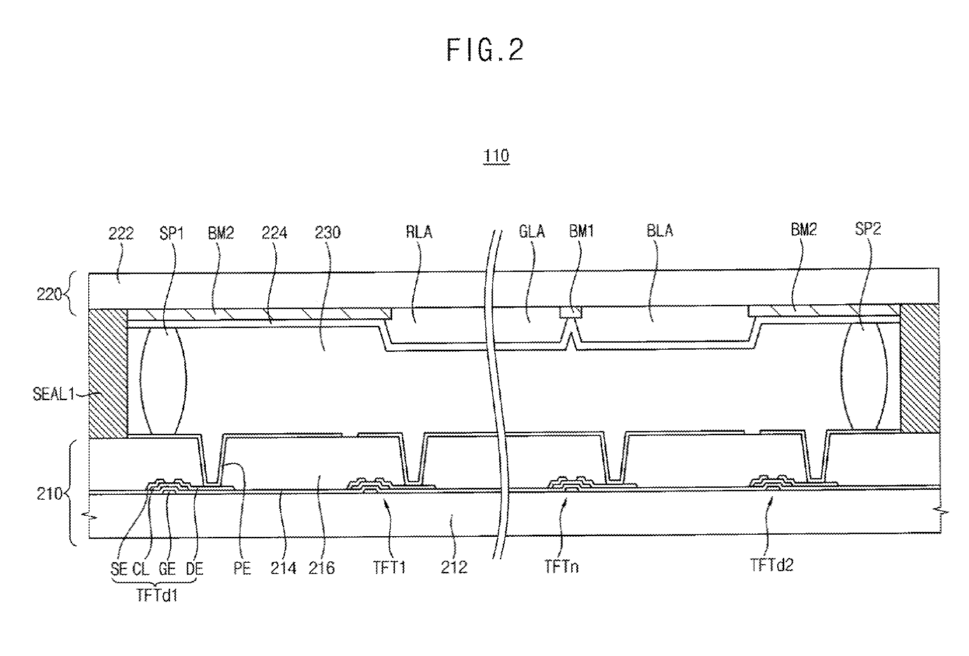

FIG. 2 is a cross-sectional view of the LCD panel shown in FIG. 1 in accordance with an embodiment of the present invention. FIG. 2 shows the LCD panel having the light shielding layer covering the dummy pixels.

Referring to FIGS. 1 and 2, the LCD panel 110 includes an array substrate 210, an opposite substrate 220 facing the array substrate 210, and a liquid crystal layer 230 interposed between the array substrate 210 and the opposite substrate 220. The array substrate 210 and the opposite substrate 220 are sealed by a first sealing material SEAL1, which is disposed at end portions of the array substrate 210 and the opposite substrate 220 to define a sealed space. The liquid crystal layer 230 is contained in the sealed space.

The array substrate 210 includes a first dummy thin film transistor (TFT) TFTd1 formed on a first transparent substrate 212, a plurality of TFTs TFT1, TFT2, . . . , TFTn: and a second dummy TFT TFTd2. In an embodiment of the present invention, the first dummy TFT TFTd1 includes a gate electrode GE, a gate insulation layer 214 formed on the gate electrode GE, a channel layer CL formed on the gate insulation layer 214 and covering the gate electrode GE, a source electrode SE formed on one portion of the channel layer CL, and a drain electrode DE formed on another portion of the channel layer CL. An organic insulation layer 216 is formed on the first dummy TFT TFTd1. The organic insulation layer 216 is partially removed to thereby expose a portion of the drain electrode DE. The exposed portion of the drain electrode DE is electrically connected to a pixel electrode PE.

The plurality of TFTs TFT1, TFT2, . . . , TFTn, and the second dummy TFT TFTd2 may have substantially the same structure as that of the first dummy TFT TFTd1.

The opposite substrate 220 includes a first light shielding layer BM1 defining pixel regions in the display area and a second light shielding layer BM2 defining the display area, each of which is formed on a second transparent substrate 222. In an embodiment of the present invention, the first light shielding layer BM1 has a width narrower than that of the second light shielding layer BM2.

A color filter layer is formed in the pixel region on the second transparent substrate 222. The color filter layer for example, includes a red filter layer GLA, a green filter layer GLA and a blue filter layer BLA.

The second light shielding layer BM2 covers the first dummy pixels of the first pixel part 112, and the second dummy pixels of the second pixel part 114.

A common electrode layer 224 is formed on the color filter layer and the first and second light shielding layers BM1 and BM2.

The LCD panel 110 includes the first sealing material SEAL1 for preventing the liquid crystal layer 230 from leaking out of the LCD panel 110.

A first short point SP1 and a second short point SP2 are formed in the LCD panel 110, The first short point SP1 electrically connects the pixel electrode PE, which is electrically connected to the first dummy TFT TFTd1, to the common electrode layer 224. The second short point SP2 electrically connects the pixel electrode PE, which is electrically connected to the second dummy TFT TFTd2, to the common electrode layer 224.

The first and second dummy pixels, which are formed to compensate charge rate differences between adjacent pixels included in the LCD panel 110 having the AAT structure, are covered with the second light shielding layer BM2.

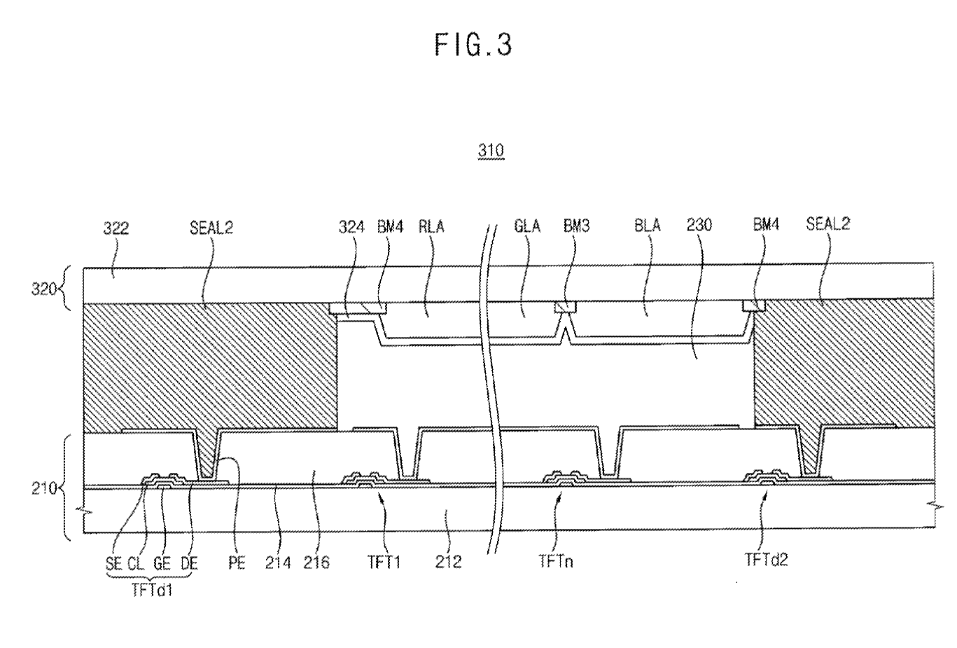

FIG. 3 is a cross-sectional view of an LCD panel in accordance with an embodiment of the present invention. FIG. 3 shows an LCD panel having a sealing material covering dummy pixels.

Referring to FIG. 3, an LCD panel 310 includes an array substrate 210, an opposite substrate 320 facing the array substrate 210, and a liquid crystal layer 230 interposed between the array substrate 210 and the opposite substrate 320.

The opposite substrate 320 has a third light shielding layer BM3 defining pixel regions in the display area, and a fourth light shielding layer BM4 defining the display area, each of which is formed on a second transparent substrate 322. The third light shielding layer BM3 may have a width substantially the same as that of the fourth light shielding layer BM4. In an alternative embodiment, the third light shielding layer BM3 may have a width different from that of the fourth light shielding layer BM4.

A color filter layer is formed in the pixel region on the second transparent substrate 322. The color filter layer, for example, includes a red filter layer RLA, a green filter layer GLA and a blue filter layer BLA.

A common electrode layer 324 is formed on the color filter layer and the third and fourth light shielding layer BM3 and BM4.

The array substrate 210 and the opposite substrate 320 are sealed by the S second sealing material SEAL2, which is disposed at end portions of the array substrate 210 and the opposite substrate 320, to define a sealed space. The liquid crystal layer 230 is contained in the sealed space. The second sealing material SEAL2 covers the first dummy pixels of the first pixel part 112 and the second dummy pixels of the second pixel part 114.

The LCD panel 310 may further include short points. In an embodiment of the present invention, one short point electrically connects the pixel electrode PE, which is electrically connected to the first dummy TFT TFTd1, to the common electrode layer 324. The other short point electrically connects the pixel electrode PE, which is electrically connected to the second dummy TFT TFTd2, to the common electrode layer 324.

The first and second dummy pixels, which are formed to compensate charge rate differences between adjacent pixels included in the liquid crystal display panel 310 having the AAT structure, are covered with the second sealing material SEAL2.

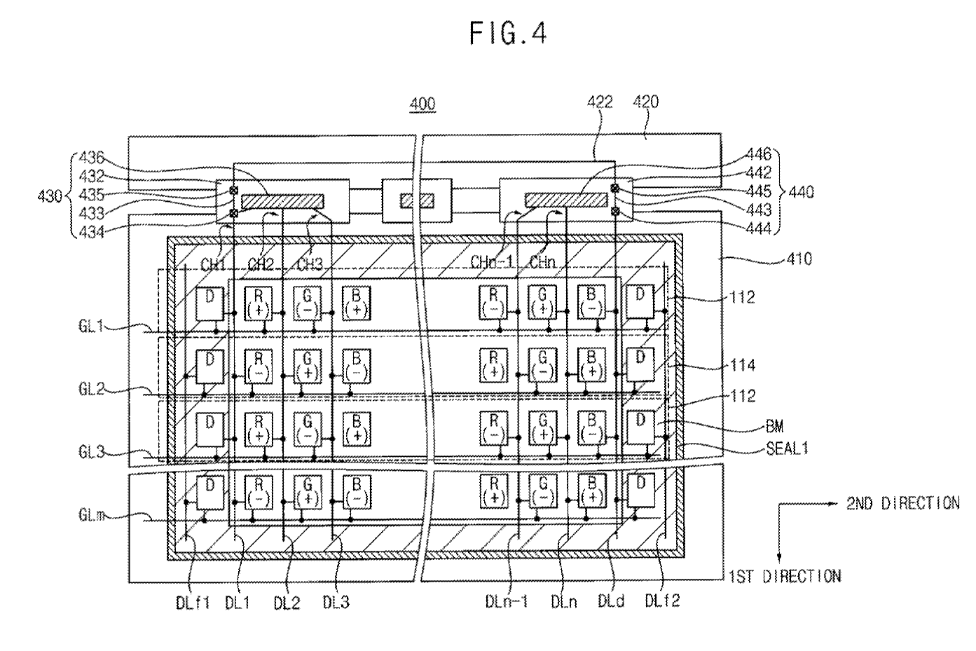

FIG. 4 is a block diagram illustrating an LCD device in accordance with an embodiment of the present invention. FIG. 4 shows an LCD device including a data driving chip without a dummy line.

Referring to FIG. 4, an LCD device 400 includes an LCD panel 410, a PCB 420, a first data driving unit 430 and a second data driving unit 440.

The PCB 420 is disposed adjacent to a side portion of the LCD panel 410. The PCB 420 includes, for example, a timing control part (not shown) and a power source convert part (not shown). The timing control part receives image signals provided from outside and sync signals corresponding to the image signals. The power source convert part converts a source voltage provided from outside.

The PCB 420 may further include a signal wiring electrically connecting the first data driving unit 430 to the second data driving unit 440.

The first and second data driving units 430 may be disposed between the LCD panel 410 and the PCB 420. In an embodiment of the present invention, more data driving units may be disposed between the first and second data driving units 430 and 440.

The first data driving unit 430 includes a first FPC board 432, a first dummy wiring 433 formed on the first FPC board 432, a first connecting part 434, a second connecting part 435 and a first gate driving chip 436 mounted on the first FPC board 432. The first and second connecting parts 434 and 435 are formed at both ends of the first dummy wiring 433. A first channel CH1 of the first gate driving chip 436 that is 15 disposed the most left among channels CH1, CH2, . . . , CHn is electrically connected to the first data line DL1, and transfers a first data signal to the first data line DL1. The first channel CH1 is electrically connected to the first connecting part 434, and transfers the first data signal to the second connecting part 435 through the first dummy wiring 433. The second connecting part 435 is electrically connected to a signal wiring 422 formed on the PCB 420.

The second data driving unit 440 includes a second FPC board 442, a second dummy wiring 443 formed on the second FPC board 442, a third connecting part 444, a fourth connecting part 445 and a second gate driving chip 446 mounted on the second FPC board 442. The third and fourth connecting parts 444 and 445 are formed at both ends of the second dummy wiring 443. An n-th channel CHn of the second gate driving chip 446 that is disposed to the most right among the channels CH1, CH2, . . . , CHn is electrically connected to the n-th data line DLn, and transfers an n-th data signal to the n-th data line DLn.

The third connecting part 444 is electrically connected to the dummy data line DLd formed in the LCD panel 410. The fourth connecting part 445 is electrically connected to the signal wiring 422 formed on the PCB 420.

Accordingly, unit pixels electrically connected to the dummy data line DLd charge the first data signal provided through the first data line DL1. That is, the most right pixels of the first effective pixels that are disposed in the most right column in the effective unit pixel matrix and the left dummy pixels that are disposed to the left of the display area charge the same data signal having the same polarity. The most left pixels of the second effective pixels that are disposed in the most left column in the effective unit pixel matrix and the right dummy pixels that are disposed to the right of the display area charge the same data signal having the same polarity.

According to an embodiment of the present invention, an LCD device having an AAT structure has dummy pixels disposed to the right or left of a display area. Thus, a charge rate of adjacent pixels is substantially the same so that display defects generated by charge rate differences may be prevented. The dummy pixels may be covered with a light shielding layer or a sealing material.

Although exemplary embodiments of the present invention have been described with reference to the accompanying drawings, it is to be understood that the present invention should not be limited to these precise embodiments but various changes and modifications can be made by one skilled in the art without departing from the spirit and scope of the present invention as hereinafter claimed.

What is claimed is:

1. An array substrate comprsing:
a first pixel part including a plurality of first effective pixels and a plurality of first dummy pixels, wherein the first effective pixels are disposed in a display area, and the first dummy pixels are disposed in a peripheral area, wherein the peripheral area is formed around the display area; and
a second pixel part including a plurality of second effective pixels and a plurality of second dummy pixels wherein the second pixel part is adjacent to the first pixel part, wherein the second effective pixels are disposed in the display area, and the second dummy pixels are disposed in the peripheral area.

2. The array substrate of claim 1, wherein adjacent pixels of the first effective pixels charge data signals having different polarities from each other.

3. The array substrate of claim 1, wherein adjacent pixels of the second effective pixels charge data signals having different polarities from each other.

4. The array substrate of claim 1, wherein the first and second dummy pixels are disposed in portions of the peripheral area that are adjacent to the first and second effective pixels, respectively.

5. The array substrate of claim 1, wherein the first and second pixel parts are arranged in a first direction that is substantially perpendicular to a second direction, and each of the first and second pixel parts has a plurality of unit pixels disposed in the second direction.

6. An array substrate comprising;
a plurality of gate lines arranged in a first direction, wherein each of the plurality of gate lines is extended in a second direction and
a plurality of data lines each of which is extended in the first direction and intersects the plurality of gate lines to define a plurality of unit pixel areas,
wherein a first pixel part and a second pixel pad are alternately arranged in the first direction in the unit pixel areas, wherein the first pixel part includes first effective pixels and first dummy pixels disposed in the second direction and the second pixel part includes second effective pixels and second dummy pixels disposed in the second direction, wherein the data lines include:
a first data line electrically connected to the first dummy pixels and the second effective pixels;
a second data line to an n-th data line electrically connected to the first effective pixels and the second effective pixels, the second data line being adjacent to the first data line, and
a dummy data line electrically connected to the first effective pixels and the second dummy pixels, the dummy data line being adjacent to the n-th data line.

7. The array substrate of claim 6, wherein a first pixel and a last pixel of the first dummy pixels are electrically connected.

8. The array substrate of claim 6, wherein a first pixel and a last pixel of the second dummy pixels are electrically connected.

9. The array substrate of claim 6, wherein each of the dummy pixels has substantially the same size as that of each of the effective pixels adjacent to the dummy pixels to compensate for a difference of charge rate of the adjacent effective pixels.

10. The array substrate of claim 6, wherein odd-numbered data lines and even-numbered data lines transfer data signals having different polarities from each other.

11. A liquid crystal display (LCD) device comprising:
an upper substrate;
a liquid crystal layer; and
a lower substrate combined with the upper substrate to contain the liquid crystal, wherein the lower substrate includes:
a first pixel part having a plurality of first effective pixels disposed in a display area and a plurality of first dummy pixels disposed in a peripheral area formed around the display area; and
a second pixel part having a plurality of second effective pixels disposed in the display area and a plurality of second dummy pixels disposed in the peripheral area, the second pixel part being adjacent to the first pixel part.

12. The LCD device of claim 11, wherein the first and second dummy pixels are disposed in portions of the peripheral area that are adjacent to the first and second effective pixels respectively.

13. The LCD device of claim 11, further comprising a covering part covering the first and second dummy pixels.

14. The LCD device of claim 13, wherein the covering part comprises a light shielding layer formed on the upper substrate and defining an effective display area.

15. The LCD device of claim 13, wherein the covering part comprises a sealant interposed between the upper and lower substrates.

16. The LCD device of claim 11, further comprising a plurality of data driving parts supplying a plurality of data signals to each of the first and second pixel parts,
wherein a data driving part disposed at an extreme side of the data driving parts further includes a dummy line,
wherein the dummy line is electrically connected to effective pixels disposed at the extreme side of the first effective pixels and to dummy pixels disposed at the extreme side of the display area of the second dummy pixels.

17. The LCD device of claim 16, wherein dummy pixels disposed at the extreme side of the display area in the first dummy pixels are electrically connected to each other.

18. The LCD device of claim 16, wherein dummy pixels disposed at another extreme side of the display area in the first dummy pixels are electrically connected to each other.

19. The LCD device of claim 11, further comprising a plurality of data driving parts supplying a plurality of data signals to each of the first and second pixel parts,
wherein the data driving parts include a plurality of data lines,
wherein a data line disposed at a first extreme side and a data line disposed at a second extreme side of the data lines are electrically connected.

20. The LCD device of claim 19, wherein effective pixels disposed at the first extreme side of the first effective pixels and the dummy pixels disposed at the second extreme side of the display area in the first dummy pixels charge substantially the same data signal.

21. The LCD device of claim 19, wherein effective pixels disposed at the second extreme side of the second effective pixels and the dummy pixels disposed at the first extreme side of the display area of the second dummy pixels charge substantially the same data signal.

22. The LCD device of claim 19, wherein the dummy pixels disposed to the left of the display area of the first dummy pixels are electrically connected to each other.

23. The LCD device of claim 194 wherein the dummy pixels disposed to the right of the display area of the second dummy pixels are electrically connected to each other.

24. The LCD device of claim 11, wherein the upper substrate further comprises a common electrode layer, and wherein dummy pixels disposed to the right of the display area of the first dummy pixels are electrically connected to the common electrode layer through a short point.

25. The LCD device of claim 11, wherein the upper substrate further comprises a common electrode layer, and wherein dummy pixels disposed to the left of the display area of the second dummy pixels are electrically connected to the common electrode layer through a short point.

26. The LCD device of claim 11, further comprising;
a plurality of data driving parts supplying a plurality of data signals to each of the first and second pixel parts, and
a PCB electrically connected to the data driving parts,
wherein the data driving parts include a plurality of data lines, and a data driving part disposed at a first extreme side of the data driving parts further includes a dummy line, wherein the PCB further comprises a conductive wiring for electrically connecting the dummy line and a data line disposed at a second extreme side of the data lines.
